(19) United States
(12) Patent Application Publication
(10) Pub. No.: US 2017/0244783 A1
(43) Pub. Date: Aug. 24, 2017

(54) FEDERATING GEOGRAPHICALLY DISTRIBUTED NETWORKS OF MESSAGE BROKERS INTO A SCALABLE CONTENT DELIVERY NETWORK

(71) Applicant: Verisign, Inc., Reston, VA (US)

(72) Inventor: Paolo MARESCA, Fribourg (CH)

(21) Appl. No.: 15/050,386

(22) Filed: Feb. 22, 2016

(51) Int. Cl. H04L 29/08

(52) U.S. Cl. CPC H04L 67/104; H04L 67/1097

(57) ABSTRACT

One embodiment of the invention disclosed herein provides techniques for managing data access in a distributed computing system. A site engine detects a first subscription request from a first subscriber for a first data object included in a plurality of data objects. The site engine determines whether the first data object is locally available within a first site that is included in a plurality of sites and associated with the first subscriber. If the first data object is locally available within the first site, then the site engine services the first subscription request locally within the first site. If the first data object is not locally available within the first site, then the site engine establishes a peer-to-peer relationship with a second site that is included in the plurality of sites for accessing the first data object via the second site.

### BACKGROUND OF THE INVENTION

Field of the Invention

The present invention relates generally to computer networks and data distribution and, more specifically, to federating geographically distributed networks of message brokers into a scalable content delivery network.

Description of the Related Art

In the domain of distributed computing, producers of data and consumers of data are typically dispersed over a large geographic area, often spanning multiple countries or continents. In such distributed topologies, each producer of data and each consumer of data typically communicates with, and is served by, a local edge site. An edge site is a single server or a cluster of two or more servers configured to interface between two different networks—typically an a local area network (LAN), such as a private enterprise network, and a wide area network (WAN), such as the Internet. When fulfilling a data request, if a data consumer that is served by a particular edge site requests data from a data producer that is served by the same edge site, then the edge site transfers the requested data from the data producer to the data consumer via the LAN. If, however, the data consumer and the data producer are served by different edge sites, then the edge site that serves the data consumer directs a message containing a data request via the WAN to the edge site that serves the data producer. In response, the edge site that serves the data producer directs a message via the WAN to the edge site that serves the data consumer that includes the requested data from the data producer.

Whether the data producer and the data consumer are served by the same or by different edge sites, the edge site that serves the data consumer sometimes transmits a single data request referred to herein as a “subscription request.” In response to receiving a subscription request, the edge site that serves the data producer continues to transmit messages with updated data from the data producer, as the data producer publishes new data. Such a message exchange protocol is referred to herein as a “publish/subscribe (pub/sub) service.”

One drawback of the above approach is that, in general, message transfers from a data producer to a data consumer via a WAN generally have much longer latencies relative to similar message transfers via a LAN. In particular, message latencies are particularly high and difficult to predict between edge sites operating on different continents due to reliability issues and the long communications paths between distant edge sites. Consequently, data that is produced by a remote data producer can be delayed significantly relative to data that is produced by a more local data producer. In addition, each message transferred from a particular data producer to a particular data consumer may travel via a different routing path over the WAN. As a result, successive messages from a particular data producer to a particular data consumer can experience differing amounts of delay, leading to irregular intervals between successive messages. The overall impact of one or more of these drawbacks is that data consumers may not receive data from data producers in sufficient time or with the regularity needed to perform required operations on that data.

As the foregoing illustrates, what is needed are more effective ways for data to be transmitted between data producers and data consumers in a distributed computing environment.

### SUMMARY OF THE INVENTION

Various embodiments of the present application set forth a method for federating message brokers in a distributed computing system. The method includes detecting a first subscription request from a first subscriber for a first data object included in a plurality of data objects. The method further includes determining whether the first data object is locally available within a first site that is included in a plurality of sites and associated with the first subscriber. The method further includes, if the first data object is locally available within the first site, then servicing the first subscription request locally within the first site. The method further includes, if the first data object is not locally available within the first site, then establishing a peer-to-peer relationship with a second site that is included in the plurality of sites for accessing the first data object via the second site.

Other embodiments of the present invention include, without limitation, a computer-readable medium including instructions for performing one or more aspects of the disclosed techniques, as well as a computing device for performing one or more aspects of the disclosed techniques.

At least one advantage of the disclosed techniques is that data is transferred from data producer to data consumer with reduced latency and greater reliability relative to prior approaches. Another advantage of the disclosed techniques is that when a particular path between two edge sites fails because of an error associated with a particular intermediate site, a new path between the two edge sites is automatically established based on the shortest path the two edge sites via one or more alternative edge sites that share the requested data. As a result, data is transferred between edge sites with reduced latency and improved reliability.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a system configured to implement one or more aspects of the present invention;

FIG. 1B illustrates an exemplary computing device configured to implement the site engine of FIG. 1A, according to various embodiments of the present invention;

FIG. 2 is a block diagram of a distributed computing system, according to various embodiments of the present invention;

FIG. 3 illustrates a data flow between a local edge site and a remote edge site, respectively associated with two of the sites of FIG. 2, according to various embodiments of the present invention;

FIGS. 4A-4C illustrate a data flow through the distributed computing system of FIG. 2, according to various embodiments of the present invention

FIG. 5 is flow diagram of method steps for managing data accesses associated with a new subscription, according to various embodiments of the present invention; and

FIG. 6 is flow diagram of method steps for managing data accesses associated with a published update corresponding to a remote subscription, according to various embodiments of the present invention.

### DETAILED DESCRIPTION

In the following description, numerous specific details are set forth to provide a more thorough understanding of the present invention. However, it will be apparent to one of skill in the art that embodiments of the present invention may be practiced without one or more of these specific details.

### Hardware Overview

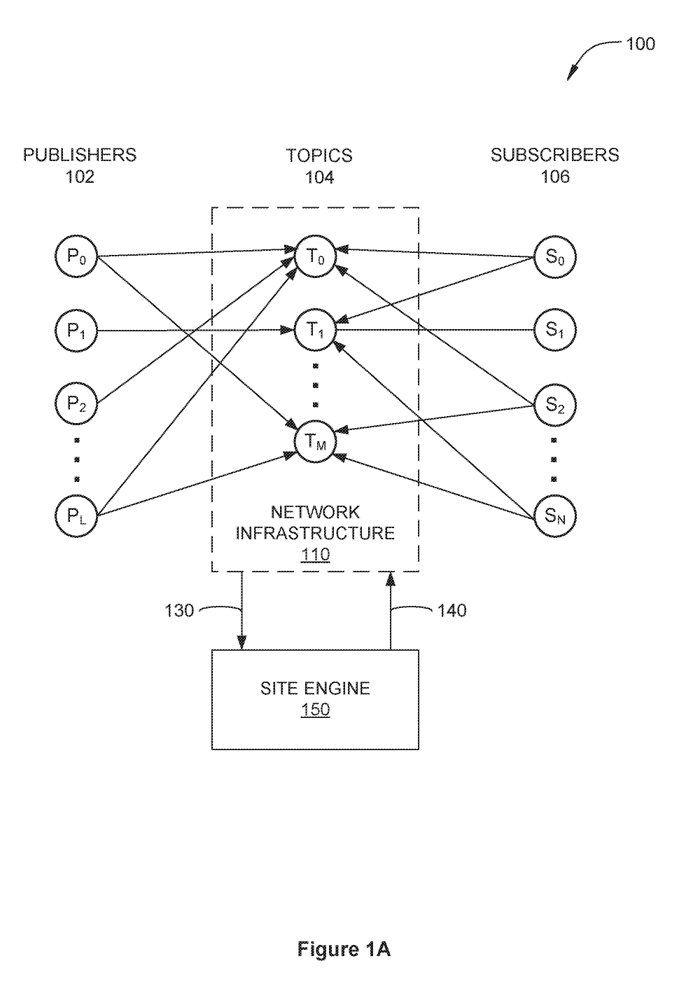

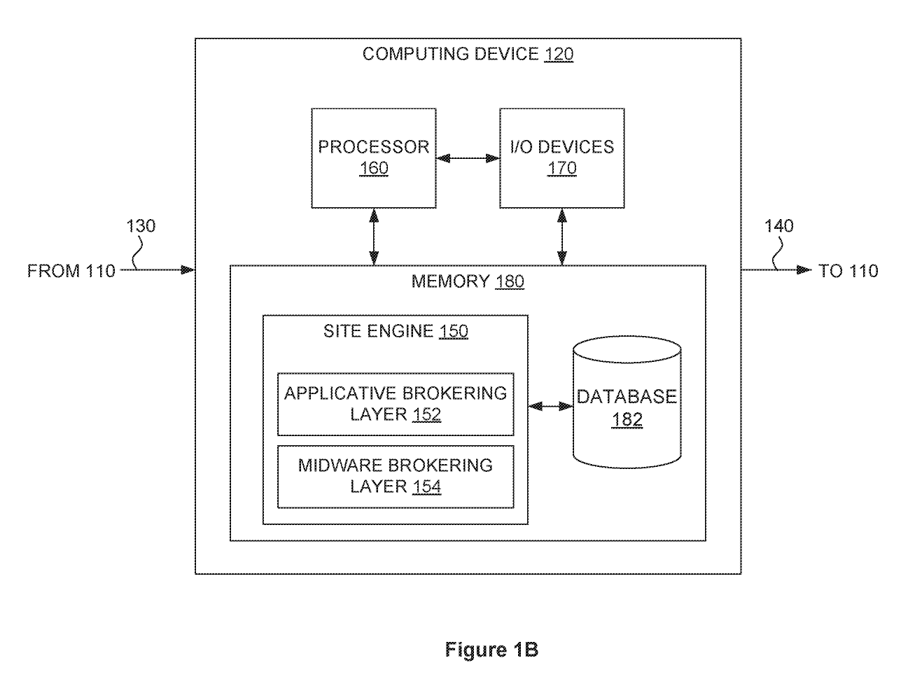

FIG. 1A illustrates a system configured to implement one or more aspects of the present invention. As shown, publish-subscribe (pub/sub) network 100 includes publishers 102, topics 104, and subscribers 106. Publishers 102 include individual publishers P₀ through P_{L}, topics 104 include individual topics T₀ though T_{M}, and subscribers 106 include individual subscribers S₀ though S_{N}. Publishers 102 are configured to publish content that is associated with individual topics 104. For example, publisher P_{L} could publish content that is associated with topics T₀ and T_{M}. Topics 104 include any data object that produces by a publisher 102 and/or consumed by a subscriber 106, including, without limitation, data related to a resource or metadata. As used herein, the terms “subject,” “resource,” “topic,” and “metadata” all refer to data objects produced by a publisher 102 and/or consumed by a subscriber 106. Subscribers 106 are configured to subscribe to content that is associated with individual topics 104. For example, subscriber S_{N} could subscribe to topics T₁ and T_{M}.

Network infrastructure 110 includes various computing and communication resources that are collectively configured to facilitate the publish-subscribe architecture described above. Network infrastructure 110 could include, for example, routers configured to move traffic through publish-subscribe network 100, server machines configured to process and respond to requests, databases that cache content at various edge locations, message queues configured to queue messages exchanged via network infrastructure 110, and so forth.

Site engine 150 is coupled to and/or integrated with network infrastructure 110 via communications channels 130 and 140. Site engine 150 is configured to receive data from publishers 102 and route the received data to one or more subscribers 106. Site engine 150 maintains a database (not explicitly shown) of various data types produced by each publisher 102 and subscribed to by each subscriber 106. Site engine further maintains a database that includes routing information associated with various sites that communicate with one another via the network infrastructure 110.

FIG. 1B illustrates an exemplary computing device 120 configured to implement the site engine 150 of FIG. 1A, according to various embodiments of the present invention. As shown, computing device 120 includes processor 160, input/output (I/O) devices 170, and memory 180.

Processor 160 may be any technically feasible form of processing device configured process data and execute program code. Processor 160 could be, for example, a central processing unit (CPU), a graphics processing unit (GPU), an application-specific integrated circuit (ASIC), a field-programmable gate array (FPGA), and so forth. I/O devices 170 may include devices configured to receive input, including, for example, a keyboard, a mouse, and so forth. I/O devices 170 may also include devices configured to produce output, including, for example, a display device, a speaker, and so forth. I/O devices 170 may further include devices configured to both receive and produce input and output, respectively, including, for example, a touchscreen, a universal serial bus (USB) port, and so forth.

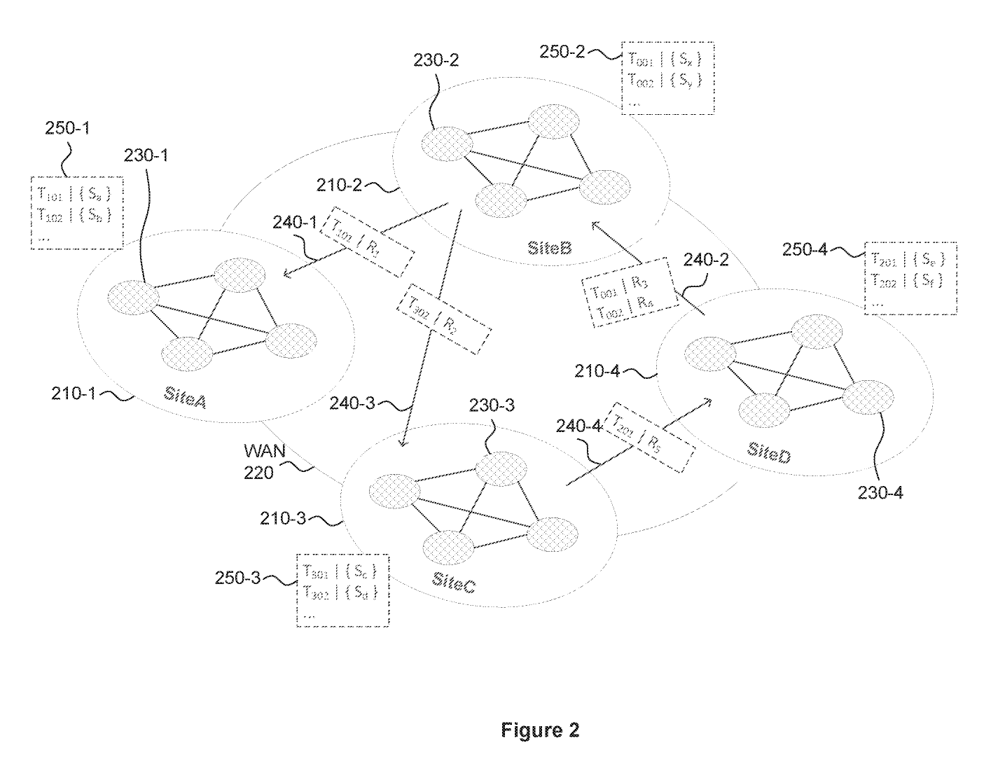

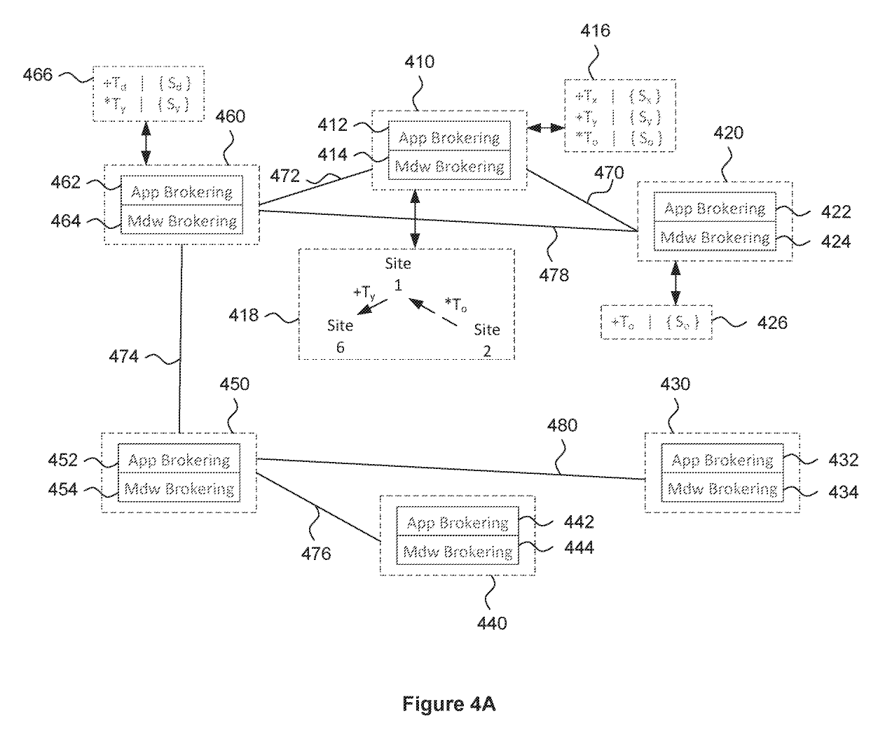

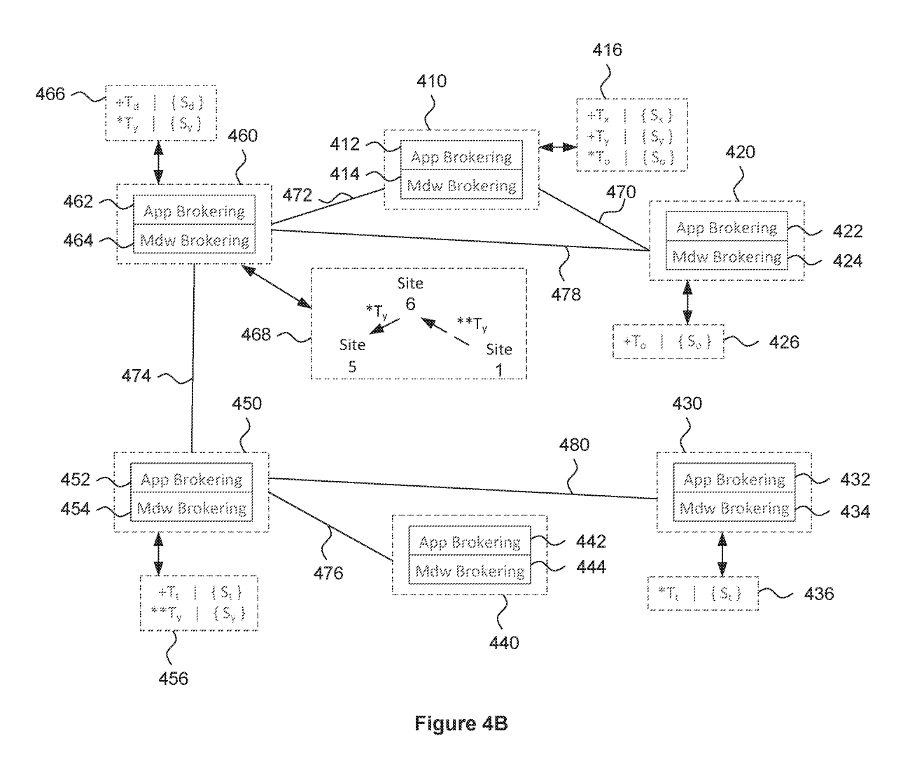

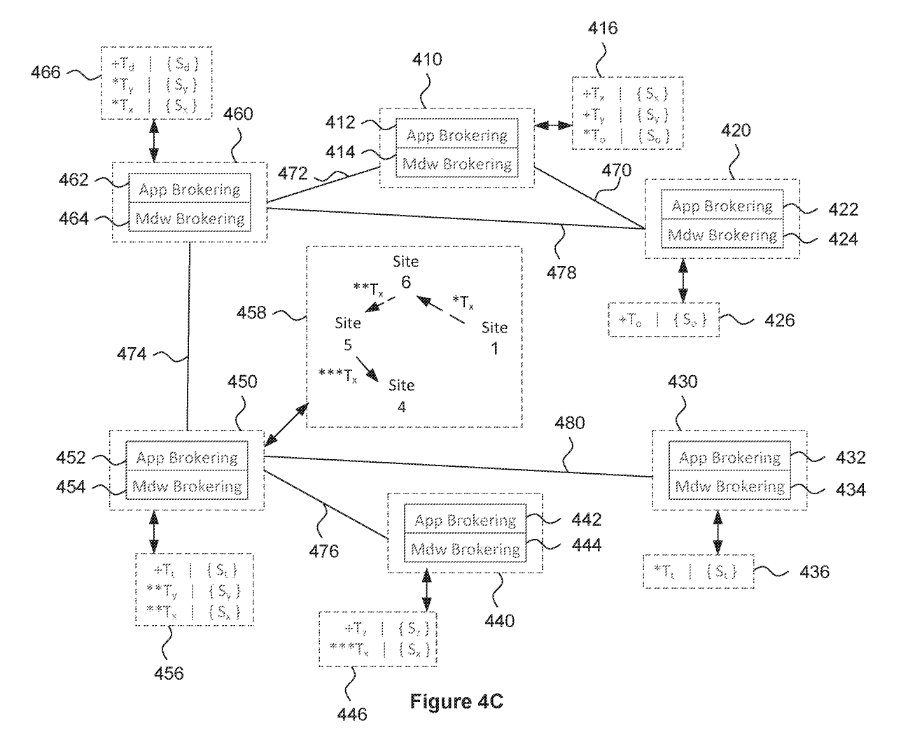

Memory 180 may be any technically feasible storage medium configured to store data and software applications. Memory 180 could be, for example, a hard disk, a random access memory (RAM) module, a read-only memory (ROM), and so forth. Memory 180 includes site engine 150 and database 182. In FIG. 1B, site engine 150 is implemented as a computer-readable medium, such as an executable application. When executed by processor 160, site engine 150 performs any and all of the data access management operations described herein. In doing so, site engine 150 may implement software versions of an applicative brokering later 152 and a middleware brokering layer 154, as described in further detail in conjunction with FIGS. 4A-4C. Data associated with the applicative brokering later 152 and the middleware brokering layer 154 may be stored in database 182. Database 182 may also reside at another location that is accessible to site engine 150. Persons skilled in the art will recognize that the software implementation discussed in conjunction with FIG. 1B represents just one possible implementation of site engine 150, and that other implementations fall equally within the scope of the claimed embodiments. The site engine 150 is described in greater detail below in conjunction with FIG. 2.

### Federating Geographically Distributed Networks of Message Brokers

FIG. 2 is a block diagram of a distributed computing system 200, according to various embodiments of the present invention. As shown, the distributed computing system 200 includes, without limitation, four sites 210-1, 210-2, 210-3, and 210-4, each representing a different domain and communicating over a wide area network (WAN) 220, such as the Internet. Each site 210-1, 210-2, 210-3, and 210-4, in turn, includes a cluster of one or more message brokers, such as message broker 230-1, 230-2, 230-3, and 230-4. The computer system 100 of FIG. 1 can be configured to implement any one or more elements of the distributed computing system 200 in any combination. For example, each of the message brokers, such as message broker 230-1, 230-2, 230-3, and 230-4 could be implemented on separate instances of computer system 100. The message brokers, such as message broker 230-1, 230-2, 230-3, and 230-4, would implement the features of the site engine 150 of FIG. 1.

Each message broker 230 communicates with the other message brokers 230 in the same site 210. Message brokers 230 that reside within the same domain communicate with one another over a local area network (LAN) and are said to be local with respect to one another. Further, at least one message broker 230 at each site 210 serves as an edge site, where an edge site provides a communications interface between the LAN of the particular site 210 and the WAN 220. Via the edge sites, message brokers 230 within a particular site 210 are configured to communicate with message brokers 230 in other sites 210. Message brokers 230 that reside in different domains communicate with one another over the WAN 220 and are said to be remote with respect to one another. In this manner, message brokers 230 within a particular site 210 operate cohesively with each other over the LAN associated with the site 210. Further, the message brokers 230 are “WAN aware” in that the message brokers 230 produce or consumer data associated with other sites 210 via a process referred to herein as middleware brokering.

Each message broker 230 is also configured to communicate with one or more publishers and subscribers (not explicitly shown). Publishers produce data from one or more data sources via messages that are transmitted via the message brokers 230 to one or more networks, such as a LAN or the WAN 220. Subscribers consume data from one or more publishers. Such a system is referred to herein as a publication/subscription (pub/sub) system. In general, publishers do not transmit data messages directly to specific subscribers. Rather, publishers transmit data messages without knowledge or regard of which subscribers, if any, that request the data produced by a particular publisher. Likewise, subscribers express interest in particular data without regard to which publishers, if any, are configured to produce the requested data. That is, there is no specific connection between a specific subscriber and a specific publisher to produce data requested by the subscriber. As a result, publishers and subscribers are essentially decoupled and, in general, are not specifically aware of one another. Data items produced by publishers and consumed by subscribers include, without limitation, data associated with resources, topics, or metadata. Although data items produced by publishers and consumed by subscribers are referred to herein as topics, such data items may be of any form or content within the scope of the present invention.

Publishers and subscribers may reside on the same computer system as the corresponding message broker 230. Alternatively, publishers and subscribers may be implemented on computer systems that are separate from the corresponding message broker 230. Such separate publishers and subscribers may be implemented on separate instances of the computer system 100 of FIG. 1.

In general, the overall resources space is partitioned over different domains, where each domain resides at a site 210, and where the sites are distributed geographically. The domains essentially function as “attraction poles” for multiple publishers/producers and multiple subscribers/consumers. In particular, the domains, via the message brokers 230 and edge sites shield subscribers from knowing whether the data is received from a local publisher, a remote publisher, or a combination of local and remote publishers. As a result, local subscribers/consumers seamlessly subscribe to topics of interest supplied remote topics, that is, topics maintained in different domains, and are notified upon any change.

If a subscriber issues a new subscription request expressing an interest in a particular topic, then the subscriber issues a subscription request to a corresponding message broker 230. A corresponding message broker 230 queries a local topics database to determine whether the requested topic is local to the site 210, that is, whether the publisher of the requested topic is within the same site 210 as the subscriber. If the publisher of the requested topic is within the same site 210 as the subscriber, then the subscription request is fulfilled locally via the LAN within the site 210. If, however, publisher of the requested topic is not within the same site 210 as the subscriber, then a discovery phase begins, where the subscription request is forwarded to the edge site within the site of the subscriber. If the topic is found in another site 210, then the edge site forms a peer-to-peer relationship with the edge site associated with the publisher via the WAN 220, where the peer-to-peer relationship is specific to the requested topic. The respective edge sites update a local routing table 250 that tracks these peer-to-peer relationships. If, however, the topic is not found, then either the topic can be created, or the subscription request can be aborted. With respect to a particular subscriber, a remote subscription acts like a local subscription. A subscriber is not specifically aware of whether a particular subscription requests is fulfilled by a local or a remote publisher. When a publisher updates a particular topic, the edge site of the site 210 where the publisher is located updates local subscribers via the LAN of the site 210 and updates remote subscribers via WAN 220 according to the peer-to-peer relationships with one or more edge sites that include subscribers interested in the topic.

In general, topics are shared dynamically among publishers and subscribers via the distributed computing system 200 illustrated in FIG. 2. As further described herein, the applicative brokering layer 152 is aware of the various topics and the nature of these topics, that is, whether the topics are locally owned or whether the topics have shared ownership across multiple sites. The middleware brokering layer 154 is aware of the network configuration, including establishing peer-to-peer relationships via the various communication paths to connect a publisher of a particular topic to a requesting subscriber of the topic. More specifically, the middleware brokering layer 154 has knowledge regarding intra-site communication within a particular site 210 via a local LAN as well as inter-site communication between two or more sites 210 via the WAN 229 and one or more local LANs.

Each site 210 maintains a database that includes, without limitation, resources, subscriptions, forwarding paths, remote paths, publishers/producers, and subscribers/consumers. Resources, nomenclated as {Ti} for all i, denotes a set of the resources/topics that are available locally. Subscriptions, nomenclated as {Sj} for all j, denotes a set of the subscriptions for resources/topics that are available locally. Forwarding paths, nomenclated as {Fk} for all k, denotes the destination paths to forward locally available resources to one or more remote sites 210. Remote paths. nomenclated as {Rz} for all z, denotes the resources detected on remote sites 210 and subscribed to by a subscriber within the local site 210. Publishers/producers, nomenclated as {Px} for all x, denotes local publishers/producers within the site 210. Subscribers/consumers, nomenclated as {Cy} for all y, denotes local subscribers/consumers within the site 210.

When a subscription request, that is, an interest in a particular resource, is received from a subscriber, an interception engine (not explicitly shown) within the corresponding site 210 first determines whether the resource is available locally, either from a local publisher, represented within the set {Ti}, or via a remote publisher already subscribed to, as represented within the set {Rz}. If the resource is locally owned/maintained, that is, the resource is represented either in the set {Ti} or in the set {Rz}, then the subscription is immediately resolved locally, and the set {Sj} is updated to reflect the new subscription. If the resource is not locally owned/maintained, then a discovery process begins in order to locate the resource within an in-memory data grid (IMDG) that includes an inventory of available resources within the distributed computing system 200.

Once the resource is located, the interception engine forwards the subscription request to the site associated with the publisher. The interception engine adds the resource to the set {Rz} and the set {Sj}. Likewise, the site associated publisher updates the sets {Sj} and {Fk} to reflect the new subscription request and the forwarding path associated with the subscriber. The forwarding path in the set {Fk} is utilized to notify the subscriber whenever new data is published by the publisher. Once the new subscription request is established, as described above, further subscription requests for the same resource are added to {Sj} and are resolved locally and immediately. That is, the discovery process need only be performed for a subscription request for a resource not previously subscribed to. Once a resource is subscribed to, the resource appears to be local to the site 210, even if the publisher of the resource is remotely located within a different site 210.

Via an analogous process, a resource is removed via an unsubscribe request. If an unsubscribe request is received for a particular resource, the unsubscribe request is forwarded to the remote site associated with the publisher of the resource in order to remove the communication path to the remote site. The local subscription set {Sj} is updated to remove the subscription associated with the resource.

As shown in FIG. 2, the local routing table 250-1 for site A 210-1 includes entries for topics T101 and T102 associated with subscription requests Sa and Sb, respectively. Site B 210-2 forwards a remote subscription request R1 240-1 for topic T101 owned originally by site A 210-1. Once the subscription request is fulfilled, Site A 210-1 and Site B 210-2 have shared ownership of topic T101 and can each service future requests for topic T101 locally. The source for topic T102 is not explicitly shown in FIG. 2.

Likewise, the local routing table 250-2 for site B 210-2 includes entries for topics T001 and T002 associated with subscription requests Sx and Sy, respectively. Site D 210-4 forwards remote subscription requests R3/R4 240-2 for topics T001 and T002 to site B 210-2. Once the subscription request is fulfilled, Site D 210-4 and Site B 210-2 have shared ownership of topics T001 and T002 and can each service future requests for topics T001 and T002 locally.

Further, the local routing table 250-3 for site C 210-3 includes entries for topics T301 and T302 associated with subscription requests Sc and Sd, respectively. Site B 210-2 forwards remote subscription request R2 240-3 for topic T302 to site C 210-3. Once the subscription request is fulfilled, Site C 210-3 and Site B 210-2 have shared ownership of topic T302 and can each service future requests for topic T302 locally. The source for topic T301 is not explicitly shown in FIG. 2.

Finally, the local routing table 250-4 for site D 210-4 includes entries for topics T201 and T202 associated with subscription requests Se and Sf, respectively. Site C 210-3 forwards remote subscription request R5 240-4 for topic T201 to site D 210-4. Once the subscription request is fulfilled, Site C 210-3 and Site D 210-4 have shared ownership of topic T201 and can each service future requests for topic T201 locally. The source for topic T202 is not explicitly shown in FIG. 2.

As a result, when a remote subscription request for a topic is fulfilled, the routing tables are updated to reflect the communication paths associated with the remote subscription request. Ownership of the associated topic is shared between the site associated with the publisher of the topic and the site(s) associated with the subscriber(s) that issued the remote subscription request(s). As a result, subscriptions for remotely located resources are replicated locally, with the result that subscriptions appear to be fulfilled locally, whether the actual publisher is within the local site 210 or within a remote site 210. Any update of a remote topic by a remote publisher is replicated locally at the site associated with the subscriber.

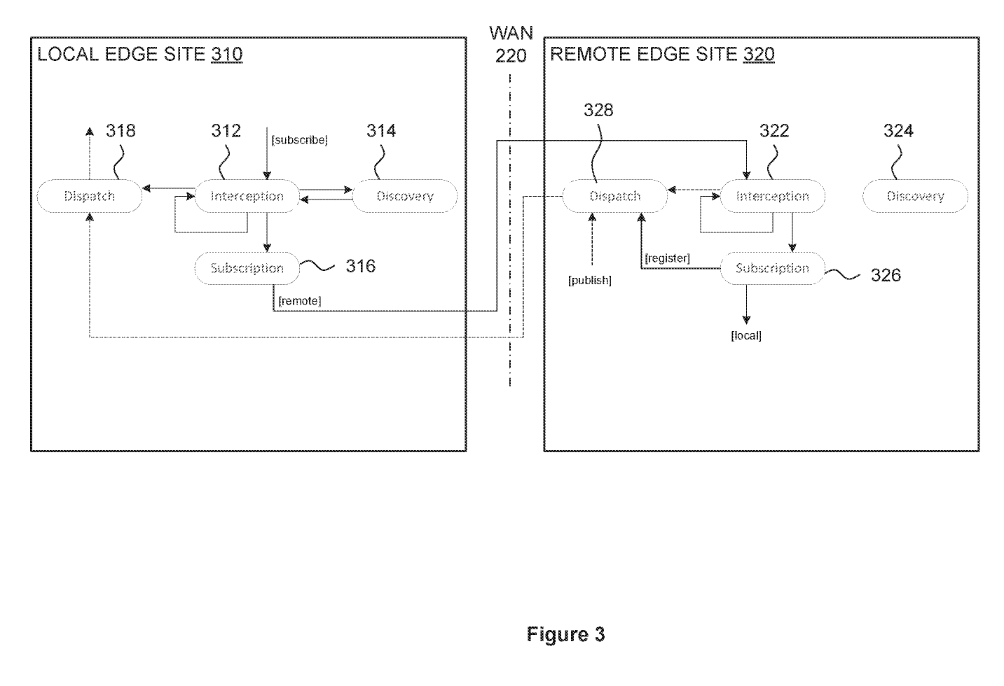

FIG. 3 illustrates a data flow between a local edge site 310 and a remote edge site 320, respectively associated with two of the sites 210 of FIG. 2, according to various embodiments of the present invention. As shown, the local edge site 310 and the remote edge site 320 communicate over the WAN 220.

The local site 310 includes an interception engine 312, a discovery engine 314, a subscription engine 316, and a dispatch engine 318. In some embodiments, the interception engine 312, discovery engine 314, subscription engine 316, and dispatch engine 318 execute on an edge site that is included within the local site 310. Likewise, the remote site 320 includes an interception engine 322, a discovery engine 324, a subscription engine 326, and a dispatch engine 328. In some embodiments, the interception engine 322, discovery engine 324, subscription engine 326, and dispatch engine 328 may execute on an edge site that is included within the remote site 320. Collectively, the interception engines 312 and 322, discovery engines 314 and 324, subscription engines 316 and 326, and dispatch engines 318 and 328 form the applicative brokering layer 152 and middleware brokering layer 154 of the site engine 150, as further described herein.

The interception engines 312 and 322 receive requests for resources, topics, or metadata from various subscribers. Upon the reception of a request, that is, an interest in some resource, topic, or metadata, the interception engine 312 of the local site 310 checks a database of resources available locally and a database of resources detected remotely and already subscribed to. If a received request is for a resource that is locally owned or maintained, that is, the resource is in one of these two databases, then the request is resolved locally and added to the list of resource subscriptions available locally. If the received request is for a resource that is not locally owned or maintained, then the interception engine 312 of the local site 310 exchanges messages with the discovery engine 314 of the local site 310 to locate the resource on the remote site 320. When the resource is located on the remote site, the interception engine 312 forwards the request to subscription engine 316, which, in turn, forwards the request to the interception engine 322 of the remote site 320 that owns the resource. The interception engine 322 of the remote site 324 updates a database to register the new remote subscription.

The discovery engines 314 and 324 maintain a list of remotely located resources. In particular, the discovery engines 314 and 324 are components within the middleware brokering layer 154 of the local site 310 and the remote site 320, respectively. The discovery engines 314 and 324 perform various functions associated with network connectivity, communication path diversity, network discovery, and peer-to-peer relationships among the message brokers within the local site 310, remote site 320, and other sites (not explicitly shown in FIG. 3) over the WAN 220. That is, the discovery engine 314 of the local site 316 maintains a list of resources available on the remote site 320 and on other remote sites on the WAN 220. Likewise, the discovery engine 324 of the local site 326 maintains a list of resources available on the local site 310 and on other remote sites on the WAN 220. The discovery engines 314 and 324 receive queries regarding requested resources from the respective interception engines 312 and 314. In response, the discovery engines 314 and 324 return metadata to the interception engines 312 and 314 that includes the address of the requested resources.

The subscription engines 316 and 326 receive requests for local and remote resources from the interception engines 312 and 314, and fulfills the requests locally or remotely as needed. If the subscription engine 316 of the local site 310 receives a request for a remote resource from the interception engine 312, then the subscription engine 312 forwards the request to the interception engine 322 of the remote site 320 that owns the resource. The interception engine 322 of the remote site 320 forwards the request to the subscription engine 322 of the remote site 320. The subscription engine 322 of the remote site 320 then forwards a registration of the new remote subscription to the dispatch engine 328.

The dispatch engines 318 and 328 receive notification of publications and updates from local and remote publishers. In particular, the dispatch engine 328 of the remote site 320 receives a notification of an update from a publisher associated with remote site 320. The dispatch engine 328 of the remote site 320 determines that the publisher is associated with a subscription from the local site 310. In response, the dispatch engine 328 of the remote site 320 forwards the notification of the update to the dispatch engine 318 of the remote site 310. The dispatch engine 318 of the remote site 310, in turn, forwards the notification to the subscriber associated with the local site 310.

The process described above occurs only upon the first request for a new resource from a subscriber. After the remote subscription between the subscriber in the local site 310 and the publisher of the remote site 320, notifications from the publisher are forwarded to the subscriber without the subscriber being aware of whether the publisher is local or remote. That is, further notifications of updates for a remote publisher are resolved as if the publisher was local to the subscriber.

Removal of an existing subscription occurs in a manner analogous to the process described above for establishing a new subscription. To remove an existing subscription, the subscription engine 316 of the local site 310 receives the unsubscribe request from the interception engine 312 of the local site 310. The subscription engine 316 of the local site 310 forwards the request to the interception engine 322 of the remote site 320. The interception engine 322 of the remote site 320 forwards the request to the subscription engine 326 of the remote site 320 to remove the subscription and update the databases accordingly. From then on, notifications of updates from the publisher in the remote site 320 are no longer forwarded to the subscriber in the local site 310. In some embodiments, the subscription engine 316 of the local site 310 may forward the request to the interception engine 322 of the remote site 320 only if the local site 310 and the remote site 320 currently share only one subscription. If the local site 310 and the remote site 320 share multiple subscriptions, then receiving an unsubscribe request as to one of the subscriptions may not result in removal of the subscription. In this manner, the local site 310 and the remote site 320 may maintain communication in order to exchange data with respect to the remaining subscriptions.

FIGS. 4A-4C illustrate a data flow through the distributed computing system 200 of FIG. 2, according to various embodiments of the present invention. As shown in FIG. 4A, sites 410, 420, 430, 440, 450, and 460 communicate over communication channels 470, 472, 474, 476, 478, and 480, where communication channels 470, 472, 474, 476, 478, and 480 are within the WAN 220.

Sites 410, 420, 430, 440, 450, and 460 include, without limitation, applicative (app) brokering layers 412, 422, 432, 442, 452, and 462, respectively. As also shown, sites 410, 420, 430, 440, 450, and 460 include, without limitation, middleware (mdw) brokering layers 414, 424, 434, 444, 454, and 464, respectively. The applicative brokering layers 412, 422, 432, 442, 452, and 462 maintain a database of topics and associated subscriptions for respective sites 410, 420, 430, 440, 450, and 460. For each topic and associated subscription, the applicative brokering layers 412, 422, 432, 442, 452, and 462 identify whether a particular topic is owned and maintained locally, or is a shared copy of a topic that is located remotely at a different site. The middleware brokering layers 414, 424, 434, 444, 454, and 464 maintain routing tables for respective sites 410, 420, 430, 440, 450, and 460. The routing tables locate each remotely subscribed topic via one or more communication paths.

As shown in FIG. 4A, site 1 410 further includes a database 416 of topics and corresponding subscriptions, and a site distribution tree 418 that identifies where remote topics are located. The database 416 includes local topic Tx associated with subscription Sx and local topic Ty associated with subscription Sy, where the plus sign “+” before the topic name identifies the topic as locally owned and maintained. The database 416 further includes remote topic To associated with subscription So, where the asterisk “*” before the topic name identifies the topic as remotely owned and maintained, where site 1 410 maintains shared ownership in topic To.

The site distribution tree 418 identifies that remote topic To is located at site 2 420. Correspondingly, the database 426 for site 2 includes local topic To associated with subscription So. The site distribution tree 418 also identifies that local topic Ty is remotely published to site 6 460. Correspondingly, the database 466 for site 6 includes remote topic Ty associated with subscription Sy. The database 466 also includes local topic Td associated with subscription Sd. Site 1 410 receives updated of topic To from site 2 420 over communications channel 470. Site 1 410 publishes updates of topic Ty to site 6 460 over communications channel 472.

As shown in FIG. 4B, site 5 450 has issued a subscription request for topic Ty associated with subscription Sy. Site 5 450 does not have a direct communications channel with site 1, the local owner of topic Ty. However, site 5 450 does have a communications channel 474 with site 6 460, where site 6 460 has shared ownership of topic Ty. Therefore, the database 456 for site 5 450 indicates that topic Ty is remotely located. The double asterisk “**” indicates that site 5 450 shares ownership of topic Ty with site 6 460, which, in turn shares ownership of topic Ty with local owner site 1 410. The database 456 also includes local topic Tt associated with subscription St. The site distribution tree 468 for site 6 460 identifies that remote topic Ty is located at site 1 410. The site distribution tree 468 also identifies that local topic Ty is remotely published to site 5 450. Site 6 460 publishes updates of topic Ty to site 5 450 over communications channel 4 474. Finally, the database 436 for site 3 430 indicates that topic Tt associated with subscription St is remotely located, being a local topic of site 5 450.

As shown in FIG. 4C, site 4 440 has issued a subscription request for topic Tx associated with subscription Sx. Site 4 440 does not have a direct communications channel with site 1, the local owner of topic Tx. However, site 5 450 can reach site 1 410 via communications channels 476, 474, and 472 via site 5 450 and site 6 460. Therefore, the database 446 for site 4 440 indicates that topic Tx is remotely located. The triple asterisk “***” indicates that site 4 440 shares ownership of topic Tx with site 5 450, which, in turn shares ownership of topic Tx with site 6 460, which, in turn shares ownership of topic Tx with local owner site 1 410. In addition, the database 446 for site 4 440 also includes local topic Tz associated with subscription Sz.

Likewise, the database 456 for site 5 450 is updated to indicate that topic Tx is remotely located. The double asterisk “**” indicates that site 5 450 shares ownership of topic Tx with site 6 460, which, in turn shares ownership of topic Tx with local owner site 1 410. The database 466 for site 6 460 is also updated to indicate that topic Tx is remotely located. The single asterisk “*” indicates that site 6 460 shares ownership of topic Tx with local owner site 1 410. The site distribution tree 458 for site 5 450 reflects these relationships.

In some embodiments, the notification of a subscription request or interest in a resource, topic, or metadata proceeds according to the pseudocode illustrated in Table 1 below:

TABLE 1

| | |
|---|---|
| 10 | subject = resource \| topic \| metadata |
| 20 | IF NOT App.checkLocally(subject): |

| | |
|---|---|
| 30 | # remote lookup |
| 40 | peers = Mdw.getRoutingTables( ).findPeers (subject) |
| 50 | peer = None |
| 60 | # remote connection |
| 70 | WHILE not connected: |

| | |
|---|---|
| 80 | peers = peers − peer |
| 90 | peer = Mdw.peekBestPeer(peers) |
| 100 | connected = Mdw.getConnectedToPeer(peer) |

| | |
|---|---|
| 110 | Mdw.updateRoutingTables(subject) |

| | |
|---|---|
| 120 | # local brokering modification |
| 130 | App.register(interest) |

As shown in Table 1, the creation of a generating a new remote subscription request begins at line 10 where an interest or subscription in a new resource, topic, or metadata is assigned to a variable named subject. As indicated at line 20, the applicative brokering layer determines whether the resource, topic, or metadata is available locally. If the resource, topic, or metadata is not available locally, then lines 30-110 are performed. At lines 30-50, the middleware brokering layer attempts to find peers that have the requested resource, topic, or metadata by retrieving routing table entries that identify other sites include the resource, topic, or metadata, and setting a variable named peer to none. As indicated at lines 60-70, lines 80-100 are repeated until a connection is made to a remote site that has access to the resource, topic, or metadata.

At line 80, the most recently selected peer is removed from the list of potential peers. During the first iteration of lines 80-100, no peer is removed (line 50). At line 90, the middleware brokering layer determines the best peer among the potential peers. At line 100, a connection is attempted. If the connection to the current best peer is successful, then the loop at lines 70-100 terminates. If the connection to the current best peer is successful, then the loop at lines 70-100 is repeated by removing the unsuccessful peer from the list of potential peers (line 80), finding the next best potential peer (line 90), and attempting a connection with the next best potential peer (line 100). At lines 120-130, whether the subscription request was fulfilled locally or remotely, the applicative brokering layer registers the interest in a local database. From then on, the subscriber receives updates of the requested topic via the registered connection without specific knowledge of whether the topic is being updated via a local publisher or a remote publisher.

Via middleware brokering, ownership of topics is shared among the site 210 local to the publisher and any number of sites 210 connected to interested subscribers. Shared ownership in topics and corresponding peer-to-peer relationships are established dynamically and on demand as needed.

In some embodiments, the publication or modification of a resource, topic, or metadata proceeds according to the pseudocode illustrated in Table 2 below:

TABLE 2

| | |
|---|---|
| 10 | subject = resource \| topic \| metadata |
| 20 | # local and remote checks |
| 30 | IF NOT App.checkLocally(subject): |

| | |
|---|---|
| 40 | IF NOT Mdw.getRoutingTables( ).findSubjects(subject) |

| | |
|---|---|
| 50 | # overlay update |
| 60 | Mdw.createSubjects(subject) |
| 70 | Mdw.advertiseSubjectToPeers(subject) |
| 80 | # local brokering layer update |
| 90 | App.createLocally(subject) |

| | |
|---|---|
| 100 | # local and remote notifications |
| 110 | App.dispatch(subject) |
| 120 | Mdw.propagate(subject) |

As shown in Table 2, the publication or modification of a resource, topic, or metadata begins at line 10, where a publisher transmits data related to a resource, topic, or metadata is assigned to a variable named subject. As indicated at lines 20-40, lines 50-90 are performed if the resource, topic, or metadata is not found locally (line 30) or remotely (line 40). At lines 50-60, the middleware brokering level creates a new subject for the resource, topic, or metadata. At line 70, the middleware brokering level advertises the new subject to peer edge sites in other sites. At lines 80-90, the applicative brokering layer also creates a new subject for the resource, topic, or metadata. At lines 100-120, the applicative brokering layer dispatches the update to the existing or new subject to the middleware brokering layer (line 110), and the multiplicative brokering layer propagates the update to the existing or new subject to interested remote sites.

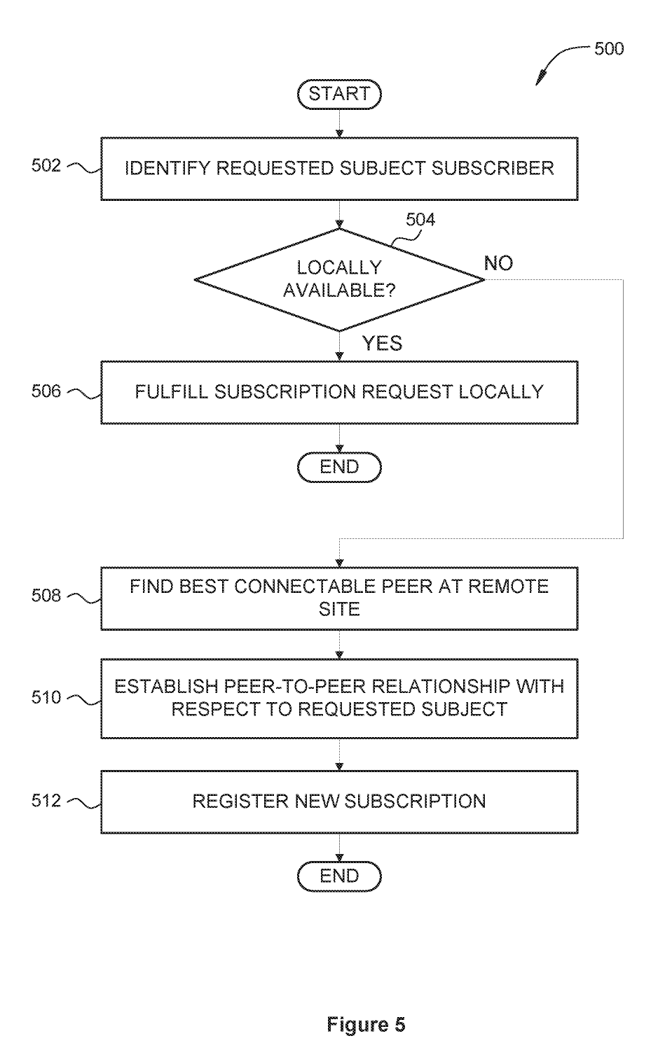

FIG. 5 is flow diagram of method steps for managing data accesses associated with a new subscription, according to various embodiments of the present invention. Although the method steps are described in conjunction with the systems of FIGS. 1-4, persons of ordinary skill in the art will understand that any system configured to perform the method steps, in any order, is within the scope of the invention.

As shown, a method 500 begins at step 502, where a message broker within a site receives identifies a subscription request associated with a particular subject. In some embodiments, the message broker is an edge site that interfaces a LAN associated with the site to a WAN that provides communication paths to other sites. The subject could include, without limitation, information associate with a resource, topic, or metadata. In general, the message broker identifies subscription requests from subscribers that communicate to the message broker via the LAN associated with the site.

At step 504, the message broker determines whether the subject is available locally. The subject is available locally if the subject is published by a publisher that is within the same site as the subscriber and the message broker. The subject is also available locally if the subject is published by a publisher at a remote site if a peer-to-peer relationship has already been established with the remote site with respect to the subject. If the subject is available locally, then the method 500 proceeds to step 506, where the message broker fulfills the subscription locally. The message broker registers the new subscription for the locally available subject. The subscriber subsequently receives updates associated with the subject when published by the publisher, whether the publisher is local or remote. The method 500 then terminates.

If, however, at step 504, the subject is not available locally, then the method 500 proceeds to step 508, where the message broker finds the best path to a connectable site within the WAN that includes the subject. The message broker finds the best path by first determining all sites that maintain shared or local ownership of the subject. The message broker selects the best path based on one or more factors, including, without limitation, shortest geographical distance, shortest latency, and highest reliability. The message broker attempts to connect to the site associated with the best path. If the attempt fails, the message broker selects the next best path and attempts to connect with the associated site. The message broker continues this process until a connection is to a suitable site.

At step 510, the message broker establishes a peer-to-peer relationship with the connected site with respect to the requested subject. The message broker updates routing tables and a local database to store relevant details regarding the subject and the communications path to the connected site. At step 512, the message broker registers the new subscription and advertises to the WAN that the local site is now a shared owner of the subject. The method 500 then terminates.

After one or more subscriptions have been registered, according to the exemplary method described in conjunction with FIG. 5, the requesting subscribers are configured to receive published data objects from corresponding publishers. These data objects include, without limitation subjects, resources, topics, and metadata. The method for propagating data objects published by a publisher to subscribers expressing an interest in such data objects is now described.

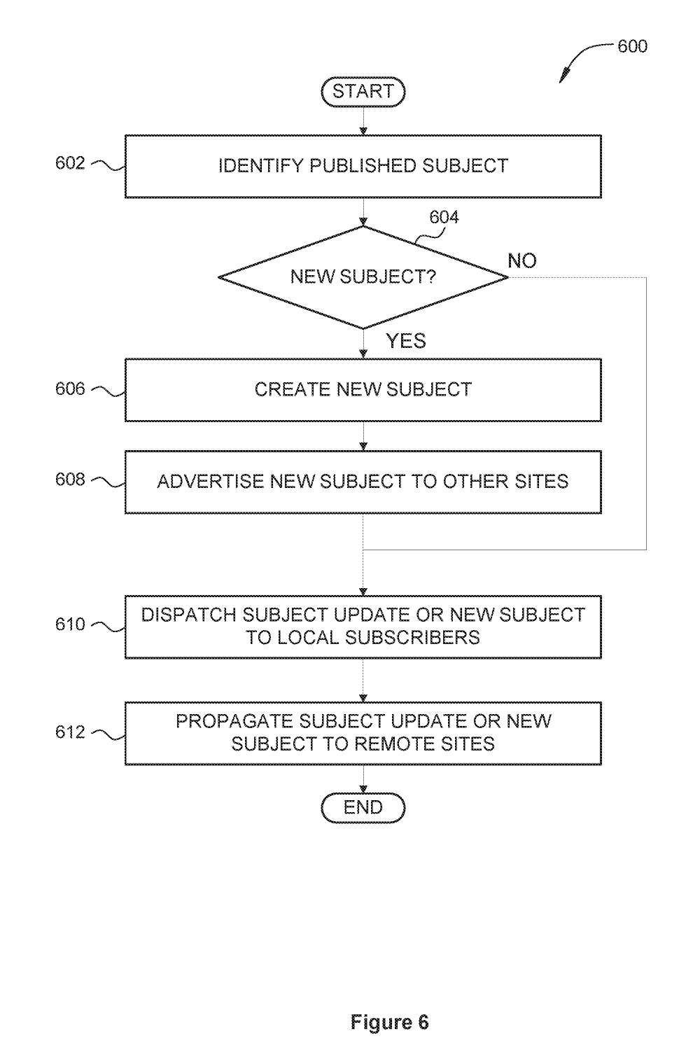

FIG. 6 is flow diagram of method steps for managing data accesses associated with a published update corresponding to a remote subscription, according to various embodiments of the present invention. Although the method steps are described in conjunction with the systems of FIGS. 1-4C, persons of ordinary skill in the art will understand that any system configured to perform the method steps, in any order, is within the scope of the invention.

As shown, a method 600 begins at step 602, where a message broker within a site receives identifies a publication associated with a particular subject. In some embodiments, the message broker is an edge site that interfaces a LAN associated with the site to a WAN that provides communication paths to other sites. The subject could include, without limitation, information associate with a resource, topic, or metadata. The subject may be published by a publisher that is local to the message broker and within the same LAN as the message broker. Alternatively, the publisher may be with a remote site and publishes a subject for which the message broker maintains shared ownership.

At step 604, the message broker determines whether the subject is a new subject that is not previously recorded in a local database of subjects. If the subject is a new subject, then the method proceeds to step 606, where the message broker creates the new subject. The message broker adds the new subject to the local database of subjects.

At step 608, the message broker advertises the new subject to other sites within the WAN. In so doing, other sites are able to fulfill new subscription requests for the new subject by communicating with the message broker. At step 610, the message broker dispatches the subject to any local subscribers that have subscribed to the topic. At step 612, the message broker propagates the subject to any remote sites associated with remote subscribers that have subscribed to the topic. The method 600 then terminates.

Returning to step 604, if the subject is not a new subject, then the method proceeds directly to step 610, described above.

In sum, a large-scale messaging infrastructure is formed by enabling networks and clusters of message brokers to be integrated seamlessly over a geographically distributed WAN, such as the Internet. The networks and clusters of message brokers are automatically federated by forming peer relationships on a per-resource or per-topic basis. Likewise, the network of message brokers are interconnected and propagate events on per resource-basis, avoiding unnecessary duplication of resources and topics, while achieving eventual consistency. As a result, a federated network of peer domains evolves over time, providing a high-availability infrastructure that is tolerant of network changes and faults. The network of federated message brokers is able to scale geographically as needed and grows to accommodate large volumes of inbound and outbound network traffic.

At least one advantage of the disclosed techniques is that data is transferred from data producer to data consumer with reduced latency and greater reliability relative to prior approaches. Another advantage of the disclosed techniques is that when a particular path between two edge sites fails because of an error associated with a particular intermediate site, a new path between the two edge sites is automatically established based on the shortest path the two edge sites via one or more alternative edge sites that share the requested data.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for managing data accesses in a distributed computing system, comprising:
detecting a first subscription request from a first subscriber for a first data object included in a plurality of data objects;
determining whether the first data object is locally available within a first site that is included in a plurality of sites and associated with the first subscriber; and
if the first data object is locally available within the first site, then servicing the first subscription request locally within the first site; or
if the first data object is not locally available within the first site, then establishing a peer-to-peer relationship with a second site that is included in the plurality of sites to allow the first data object to be accessed via the second site.

2. The computer-implemented method of claim 1, wherein the first data object is published by a publisher within the first site, resulting in the first data object being locally available within the first site.

3. The computer-implemented method of claim 1, wherein the first data object is published by a publisher included within a third site that is included in the plurality of sites, and the first site and the third site have shared ownership of the first data object, resulting in the first data object being locally available within the first site.

4. The computer-implemented method of claim 1, wherein the second site and a third site that is included in the plurality of sites have shared ownership of the first data object, and a first communication path between the first site and the second site has a lower latency relative to a second communication path between the first site and the third site.

5. The computer-implemented method of claim 1, further comprising:
detecting a second subscription request from a third site that is included in the plurality of sites for the first data object; and
establishing a peer-to-peer relationship with the third site for accessing the first data object via the third site.

6. The computer-implemented method of claim 1, further comprising:
detecting a request to cancel the first subscription;
determining that ownership of the first data object is shared between the first site and the second site; and
removing the peer-to-peer relationship with the second site for accessing the first data object via the second site.

7. The computer-implemented method of claim 1, further comprising:
detecting a second subscription request from the first subscriber for a second data object included in the plurality of data objects;
determining whether the second data object is locally available within the first site and associated with the first subscriber; and
if the second data object is locally available within the first site, then servicing the second subscription request locally within the first site; or
if the second data object is not locally available within the first site, then establishing a peer-to-peer relationship with a third site that is included in the plurality of sites to allow the second data object to be accessed via the third site.

8. The computer-implemented method of claim 1, wherein the data object comprises at least one of a resource, a topic, or metadata.

9. A non-transitory computer-readable storage medium including instructions that, when executed by a processor, cause the processor to manage data accesses in a distributed computing system by performing the steps of:
detecting a first subscription request from a first subscriber for a first data object included in a plurality of data objects;
determining whether the first data object is locally available within a first site that is included in a plurality of sites and associated with the first subscriber; and
if the first data object is locally available within the first site, then servicing the first subscription request locally within the first site; or
if the first data object is not locally available within the first site, then establishing a peer-to-peer relationship with a second site that is included in the plurality of sites to allow the first data object to be accessed via the second site.

10. The non-transitory computer-readable storage medium of claim 9, wherein the first data object is published by a publisher within the first site, resulting in the first data object being locally available within the first site.

11. The non-transitory computer-readable storage medium of claim 9, wherein the first data object is published by a publisher included within a third site that is included in the plurality of sites, and the first site and the third site have shared ownership of the first data object, resulting in the first data object being locally available within the first site.

12. The non-transitory computer-readable storage medium of claim 11, wherein a second subscriber that is within the first site has previously requested a subscription for the first data object, resulting in the first site and the third site having shared ownership of the first data object.

13. The non-transitory computer-readable storage medium of claim 9, wherein the second site and a third site that is included in the plurality of sites have shared ownership of the first data object, and a first communication path between the first site and the second site has a lower latency relative to a second communication path between the first site and the third site.

14. The non-transitory computer-readable storage medium of claim 9, wherein the second site and a third site that is included in the plurality of sites have shared ownership of the first data object, and a first communication path between the first site and the second site has a higher latency relative to a second communication path between the first site and the third site, and further comprising failing to establish a connection with the third site via the second communication path.

15. The non-transitory computer-readable storage medium of claim 9, further comprising:
determining that communication with the second site has failed;
locating a third site is included in the plurality of sites that has shared ownership of the first data object with the second site; and
establishing a peer-to-peer relationship with a second site that is included in the plurality of sites to allow the first data object to be accessed via the third site.

16. The non-transitory computer-readable storage medium of claim 9, further comprising:
detecting a second subscription request from a third site that is included in the plurality of sites for the first data object; and
establishing a peer-to-peer relationship with the third site for accessing the first data object via the third site.

17. A computing device, comprising:
a memory that includes a site engine; and
a processor that is coupled to the memory and, when executing the site engine, is configured to:
detect a first subscription request from a first subscriber for a first data object included in a plurality of data objects;
determine whether the first data object is locally available within a first site that is included in a plurality of sites and associated with the first subscriber; and
if the first data object is locally available within the first site, then service the first subscription request locally within the first site; or
if the first data object is not locally available within the first site, then establish a peer-to-peer relationship with a second site that is included in the plurality of sites to allow the first data object to be accessed via the second site.

18. The computing device of claim 1, wherein the first data object is published by a publisher within the first site, resulting in the first data object being locally available within the first site.

19. The computing device of claim 1, wherein the first data object is published by a publisher included within a third site that is included in the plurality of sites, and the first site and the third site have shared ownership of the first data object, resulting in the first data object being locally available within the first site.

20. The computing device of claim 1, wherein the first subscriber is located within a third site that is included in the plurality of sites, and the site engine is further configured to establish a peer-to-peer relationship with the third site to allow the first data object to be accessed via the first site.
